(19) United States
(12) Patent Application Publication
(10) Pub. No.: US 2026/0303170 A1
(43) Pub. Date: Oct. 1, 2026

(54) STATUS EXCHANGE OF OVERLAPPING BASIC SERVICE SETS CHANNEL STATE INFORMATION BASED ON COORDINATED BEAMFORMING

(71) Applicant: Samsung Electronics Co., Ltd., Suwon-si (KR)

(72) Inventors: Zigui YANG, San Jose, CA (US); Aiguo YAN, San Jose, CA (US)

(21) Appl. No.: 19/543,845

(22) Filed: Feb. 18, 2026

Related U.S. Application Data
(60) Provisional application No. 63/777,628, filed on Mar. 25, 2025.

(51) Int. Cl. H04B 7/06; H04B 7/024

(52) U.S. Cl. CPC H04B 7/0626; H04B 7/024

(57) ABSTRACT

Systems, methods, and apparatuses are disclosed for coordinated beamforming transmission between a first access point and a second access point. The method includes transmitting, at the first access point to the second access point, an invitation for a coordinated beamforming transmission that proposes a set of candidate stations associated with the first access point. The method includes receiving, at the first access point, a response that embeds an overlapping basic service set channel state information status identifying stations associated with the first access point for which the second access point has valid channel state information. The method includes using the overlapping basic service set channel state information statuses carried in the invitation and the response to select stations for the coordinated beamforming transmission.

### CROSS-REFERENCE TO RELATED APPLICATIONS

This application claims the benefit of U.S. Provisional Patent Application Serial No. 63/777,628, filed Mar. 25, 2025, which is incorporated by reference herein for all purposes.

### TECHNICAL FIELD

The disclosure relates generally to wireless systems. In particular, the subject matter relates to status exchange of overlapping basic service sets channel state information based on coordinated beamforming.

### SUMMARY

The present background section is intended to provide context only, and the disclosure of any concept in this section does not constitute an admission that said concept is prior art.

In 802.11bn coordinated beamforming (Co-BF), both a sharing access point (AP) and a shared AP are configured to have the CSI of the OBSS links (e.g., interference links). The current standard draft does not specify a mechanism for the two APs to exchange their CSI status or CSI information.

In Wi-Fi 802.11bn, a multi-AP coordination (MAPC) feature is introduced to enable coordinated beamforming (Co-BF) between two APs. Each AP transmits to the stations (STAs) associated with itself while attempting to minimize the interference to the STAs associated with the other AP. To do that, each AP collects not only the CSI (in-BSS CSI) from its own associated STAs, but also the CSI (OBSS CSI) from the STAs associated with the other AP. The CSIs are obtained in a Co-BF sounding stage and used in a Co-BF transmission stage.

When scheduling Co-BF transmission, each AP is configured to obtains the knowledge about the OBSS CSI status of the other AP (e.g., which STAs the other AP has CSI knowledge of). With this knowledge, each AP can propose suitable candidates to participate in Co-BF transmission or decline to participate in the Co-BF transmission if the other AP schedules some STA(s) of which it does not have the OBSS CSI knowledge.

Some systems may use new frames or extra frames to exchange the CSI, which involves additional complexity on how the frames are exchanged and additional transmission time, which adds to the overhead of Co-BF transmission.

The techniques described herein provide a mechanism that allows for exchanging of CSI status between the sharing AP and the shared AP without an additional frame exchange.

In various embodiments, the systems and methods described herein include systems, methods, and apparatuses for status exchange of overlapping basic service sets channel state information based on coordinated beamforming.

In some aspects, the techniques described herein relate to a method for coordinated beamforming transmission between a first access point and a second access point in a wireless local area network, the method including: transmitting, at the first access point to the second access point and during a coordinated beamforming transmission stage, an invitation for a coordinated beamforming transmission that proposes a set of candidate stations associated with the first access point, the invitation including a first overlapping basic service set channel state information status that identifies stations associated with the second access point for which the first access point has valid channel state information; receiving, at the first access point during the coordinated beamforming transmission stage, a response that embeds a second overlapping basic service set channel state information status identifying stations associated with the first access point for which the second access point has valid channel state information; and using the first and second overlapping basic service set channel state information statuses carried in the invitation and the response to select stations for the coordinated beamforming transmission.

In some aspects, the techniques described herein relate to a method, wherein the response further includes a set of candidate stations associated with the second access point, the set selected from stations indicated in the invitation as having valid overlapping basic service set channel state information at the first access point.

In some aspects, the techniques described herein relate to a method, wherein: the response indicates acceptance or rejection of the invitation based on whether the second access point has valid overlapping basic service set channel state information for each proposed candidate station associated with the first access point, and the response embeds the second overlapping basic service set channel state information status whether the invitation is accepted or rejected.

In some aspects, the techniques described herein relate to a method, wherein the first access point, upon receiving a rejection that embeds the second overlapping basic service set channel state information status, generates a revised set of candidate stations for a subsequent coordinated beamforming transmission attempt based on the embedded status and initiates a new invitation without performing a separate channel state information status exchange sequence.

In some aspects, the techniques described herein relate to a method, wherein overlapping basic service set channel state information status of the invitation or response is encoded as a list of association identifiers of stations, each association identifier represented by an 11-bit or 12-bit field.

In some aspects, the techniques described herein relate to a method, wherein overlapping basic service set channel state information status of the invitation or response is encoded as a multi-bit bitmap in which each bit position maps to a station according to a predetermined ordering rule that is based on respective station association identifiers.

In some aspects, the techniques described herein relate to a method, wherein an overlapping basic service set channel state information status field includes a limit on a number of stations reported, the limit corresponding to a maximum number of stations supported in coordinated beamforming transmission or a memory capacity constraint of the first access point.

In some aspects, the techniques described herein relate to a method, further including: updating a local cache of overlapping basic service set channel state information status based on the statuses carried in the invitation and the response, and evicting cached overlapping basic service set channel state information according to priority or memory size constraints, the updated cache being used for a subsequent coordinated beamforming negotiation.

In some aspects, the techniques described herein relate to a method, further including embedding, in lieu of or in addition to the invitation, the first overlapping basic service set channel state information status in at least one of a management frame, a control frame, or a data frame associated with the coordinated beamforming transmission.

In some aspects, the techniques described herein relate to a method for coordinated beamforming transmission between a first access point and a second access point in a wireless local area network, the method including: receiving, from the first access point and during a coordinated beamforming transmission stage, an invitation for a coordinated beamforming transmission that proposes a set of candidate stations associated with the first access point, the invitation including a first overlapping basic service set channel state information status that identifies stations associated with the second access point for which the first access point has valid channel state information; transmitting, at the second access point during the coordinated beamforming transmission stage and based on the invitation, a response generated by the second access point and that embeds a second overlapping basic service set channel state information status identifying stations associated with the first access point for which the second access point has valid channel state information; and using the first and second overlapping basic service set channel state information statuses carried in the invitation and the response to select stations for the coordinated beamforming transmission.

In some aspects, the techniques described herein relate to a method, wherein the response further includes a set of candidate stations associated with the second access point, the set selected from stations indicated in the invitation as having valid overlapping basic service set channel state information at the first access point.

In some aspects, the techniques described herein relate to a method, wherein: the response indicates acceptance or rejection of the invitation based on whether the second access point has valid overlapping basic service set channel state information for each proposed candidate station associated with the first access point, and the response embeds the second overlapping basic service set channel state information status, whether the invitation is accepted or rejected.

In some aspects, the techniques described herein relate to a method, wherein overlapping basic service set channel state information status of the invitation or response is encoded as a list of association identifiers of stations, each association identifier represented by an 11-bit or 12-bit field.

In some aspects, the techniques described herein relate to a method, wherein overlapping basic service set channel state information status of the invitation or response is encoded as a multi-bit bitmap in which each bit position maps to a station according to a predetermined ordering rule that is based on respective station association identifiers.

In some aspects, the techniques described herein relate to a method, wherein an overlapping basic service set channel state information status field includes a limit on a number of stations reported, the limit corresponding to a maximum number of stations supported in coordinated beamforming transmission or a memory capacity constraint of the second access point.

In some aspects, the techniques described herein relate to a method, further including: updating a local cache of overlapping basic service set channel state information status based on the statuses carried in the invitation and the response, and evicting cached overlapping basic service set channel state information according to priority or memory size constraints, the updated cache being used for a subsequent coordinated beamforming negotiation.

In some aspects, the techniques described herein relate to a method, further including: the second access point determining whether to accept the invitation based on verifying a validity of overlapping basic service set channel state information for each proposed candidate station of the first access point.

In some aspects, the techniques described herein relate to a method, further including: the second access point determining whether to accept the invitation based on applying scheduling criteria including at least one of station buffer status, station data priority, or station availability.

In some aspects, the techniques described herein relate to a method, further including embedding, in lieu of or in addition to the response, the second overlapping basic service set channel state information status in at least one of a management frame, a control frame, or a data frame associated with the coordinated beamforming transmission.

In some aspects, the techniques described herein relate to a first access point including one or more processors and memory storing instructions that, when executed by the one or more processors, cause the first access point to: transmit, at the first access point to a second access point and during a coordinated beamforming transmission stage, an invitation for a coordinated beamforming transmission that proposes a set of candidate stations associated with the first access point, the invitation including a first overlapping basic service set channel state information status that identifies stations associated with the second access point for which the first access point has valid channel state information; receive, at the first access point during the coordinated beamforming transmission stage, a response that embeds a second overlapping basic service set channel state information status identifying stations associated with the first access point for which the second access point has valid channel state information; and use the first and the second overlapping basic service set channel state information statuses carried in the invitation and the response to select stations for the coordinated beamforming transmission.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods described herein include multiple advantages and benefits. For example, the disclosed techniques avoid using extra frame exchanges (e.g., new sequences) and thus reduce complexity and overhead and improve reliability (e.g., reduce chance of failure). Based on the disclosed techniques, full OBSS CSI status is made available on both APs after one CSI Invite/Response frame exchange, even if the shared (coordinated) AP rejects the Invite. The disclosed techniques help keep CSI status updated since in every Co-BF transmission, the CSI status is updated. Thus, the described techniques help improve the Co-BF transmission success rate.

### BRIEF DESCRIPTION OF THE DRAWINGS

In the following section, the aspects of the subject matter disclosed herein will be described with reference to exemplary embodiments illustrated in the figures, in which:

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates an example system in accordance with one or more implementations as described herein.

FIG. 3 illustrates an example timeline in accordance with one or more implementations as described herein.

FIG. 4 illustrates an example frame configuration in accordance with one or more implementations as described herein.

FIG. 5 illustrates an example frame configuration in accordance with one or more implementations as described herein.

FIG. 6 is a block diagram of an electronic device in a network environment, according to an embodiment.

FIG. 7 shows a system including a UE and a gNB in communication with each other.

FIG. 8 depicts a flow diagram illustrating an example method associated with the disclosed systems, in accordance with example implementations described herein.

FIG. 9 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The disclosed techniques relate to coordinated beamforming (Co-BF) in IEEE 802.11bn (Wi‑Fi 8) in relation to Multi‑AP Coordination (MAPC). In Co‑BF, two access points (APs) simultaneously transmit to their respective associated stations (STAs) while minimizing interference to the other AP’s STAs. To accomplish interference mitigation, each AP requires channel state information (CSI) for both in-basic service set (in‑BSS) links and overlapping basic service set (OBSS) links associated with the partner AP. While CSI is obtained in a sounding stage and used in a transmission stage. Some systems do not provide an efficient, reliable mechanism for exchanging OBSS CSI status—e.g., which partner STAs each AP has valid CSI for—between the APs. Some approaches that add dedicated frames or sequences introduce complexity, time, and overhead, and they fail to address that CSI status can become outdated due to channel dynamics, delayed transmission after sounding, multiple transmissions per sounding, expiration, or eviction from memory due to limited resources.

Co-BF (Coordinated Beamforming) is a feature supported in IEEE 802.11bn. In Co-BF, two APs coordinate such that for each AP when it transmits to its associated STAs it can minimize the interference to the transmission of the other AP. By doing so, it allows for two AP’s simultaneous transmission in the same frequency band while minimizing interference to each other and thus improves system performance (throughput, latency, and reliability). To do that, each AP collects CSI for both the STAs associated with itself (in-BSS CSI) and the STAs associated with the other AP (OBSS CSI). The CSI is collected in a sounding sequence.

While it is possible to obtain CSI status during sounding stage, it still requires extra frame exchange between two APs to get complete OBSS CSI status information. Furthermore, even if CSI status is exchanged during sounding stage, it may be outdated since Co-BF transmission does not necessarily follow (e.g., immediately follow) Co-BF sounding. Similarly, there might be multiple Co-BF transmissions following sounding stage, and during these multiple transmissions, the OBSS CSI may also become outdated. The reasons that the OBSS CSI status may be outdated include (a) some of the CSI may expire during this period; and/or (b) some of the OBSS CSI may be evicted due to limited memory size.

In some cases, sounding results may be obtained from multiple sounding processes, including retries, but it can be relatively difficult for an AP to track the CSI status of another AP. Also, it generally is not good practice for one device to track the status of another device’s information.

The disclosed systems and methods provide mechanisms to exchange OBSS CSI status between two APs during the Co‑BF transmission stage using existing frames, without introducing new frame exchanges or sequences. In some embodiments, the coordinating AP initiates a Co‑BF transmission by sending an Invite frame to the coordinated AP. The Invite frame may include a list of candidate STAs associated with the coordinating AP that it proposes for the upcoming Co‑BF transmission and also includes the coordinating AP’s current OBSS CSI status for the partner AP’s STAs.

After receiving or upon receipt of the invite, the coordinated AP responds with a Response frame that includes its updated OBSS CSI status for the coordinating AP’s STAs and, when accepting the invite, may propose candidate STAs associated with the coordinated AP selected from the set indicated as having valid OBSS CSI at the coordinating AP. The coordinated AP may accept or reject the invite based on its OBSS CSI status and may indicate the reason for rejection, but even if rejecting, the coordinated AP may still include OBSS CSI status in the Response frame. After the exchange of the invite and response frames, both APs possess complete, current OBSS CSI status irrespective of whether the invite was accepted or rejected, enabling more informed candidate selection in the present and subsequent Co‑BF transmissions.

In some examples, the OBSS CSI status can be a field in Co-BF Invite/Response frame. The OBSS CSI status may have a size limit (e.g. 3 or 4 OBSS stations). The OBSS CSI status may be represented in various signaling formats suitable for 802.11 frames. In some cases, the OBSS CSI status may be represented in a list of STAs, such as using a number of bits per STA (e.g., 11 or 12 bits per STA). Additionally, or alternatively, the OBSS CSI status may be represented using a multi‑bit encoding where each bit maps to a STA according to a configured ordering rule (e.g., the value of STA association IDs (AIDs)).

To simplify signaling and reflect practical constraints, the status field may include a limit on the number of OBSS STAs reported, such as a cap of three or four STAs, which may align with Co‑BF transmission sizes and memory priorities. Although Invite/Response frames can be the primary carriers to ensure status exchange occurs in every transmission negotiation without added sequences, the disclosed techniques do not preclude using other existing 802.11 frames associated with Co‑BF (e.g., management frame, control frame, and/or data frames). The disclosed techniques may be extended to scenarios with more than two APs, allowing coordinated AP clusters to maintain up‑to‑date OBSS CSI visibility.

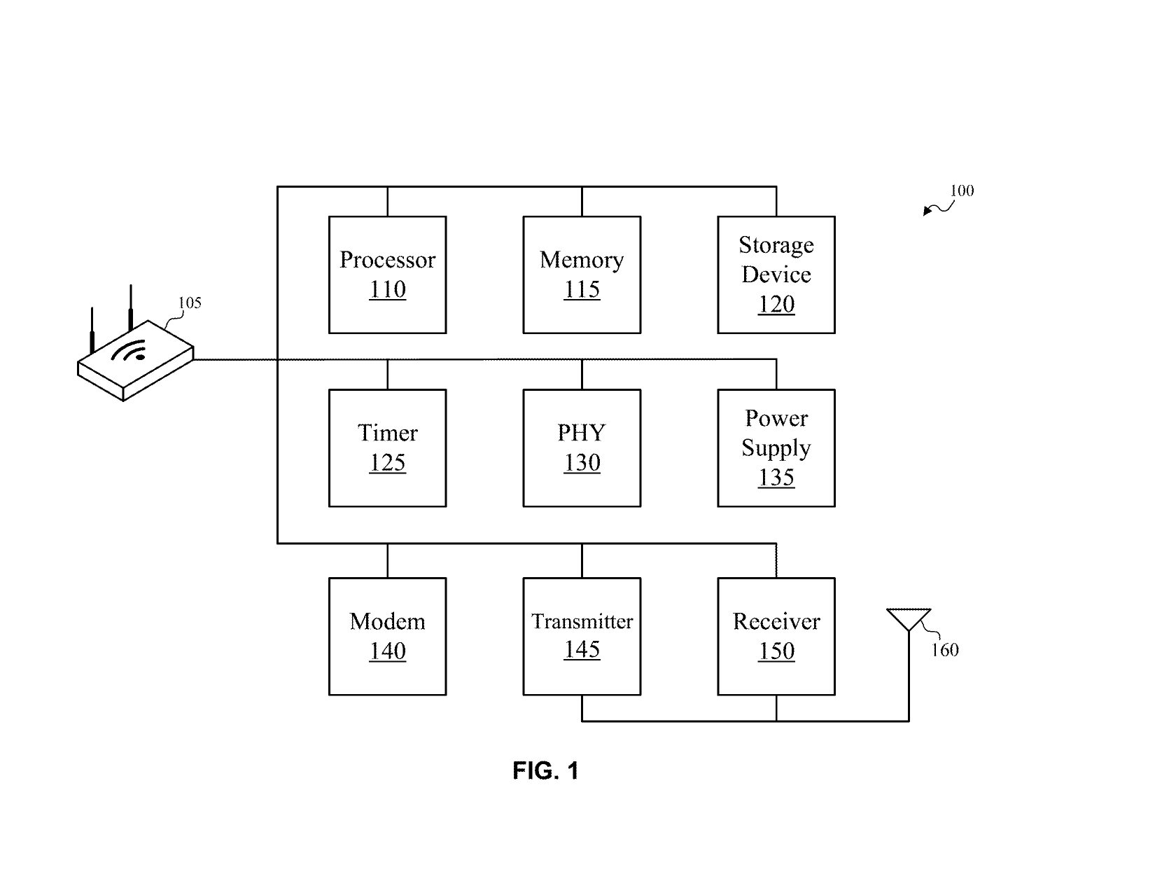

FIG. 1 illustrates an example of a system 100, of a wireless communications network, that supports status exchange of overlapping basic service sets channel state information based on coordinated beamforming with example implementations described herein.

As shown, system 100 may include device 105. Device 105 may include an access point, a mobile device, a cellphone, a smartphone, a tablet, a laptop, a wearable computing device, an Internet-of-things device, a user equipment (UE), a vehicle (e.g., autonomous vehicle), any device configured to transmit and/or receive a wireless signal, or any wireless/wired network-connected device. As shown, device 105 may include a processor 110, a memory 115, a storage device 120, a timer 125, a physical layer (PHY) 130, a power supply 135, a modem 140, at least one transceiver (e.g., transmitter 145, receiver 150), and at least one antenna (e.g., antenna 160). Device 105 may communicate with one or more devices via at least antenna 160 and at least one network (e.g., short-range wireless communication network, long-range wireless communication network).

In some cases, device 105 may include an input device, a sound output device, a display device, an audio module, a sensor module, an interface, a haptic module, a camera module, a communication module, a subscriber identification module (SIM) card, or an antenna module. In one embodiment, at least one component (e.g., display device, camera module) may be omitted from device 105, or one or more other components may be added to device 105. Some of the components may be implemented as a single integrated circuit (IC). For example, a sensor module (e.g., a fingerprint sensor, an iris sensor, or an illuminance sensor) may be embedded in a display of device 105.

As at least part of the data processing or computations, processor 110 may load a command or data received from another component (e.g., receiver 150, etc.) in memory 115, process the command or the data stored in memory 115, and store resulting data in storage device 120. In some cases, processor 110 may include a main processor (e.g., a central processing unit (CPU) or an application processor (AP)), and an auxiliary processor (e.g., a graphics processing unit (GPU), an image signal processor (ISP), a sensor hub processor, and/or a communication processor (CP)) that is operable independently from, or in conjunction with, the main processor. Additionally, or alternatively, the auxiliary processor may be adapted to consume less power than the main processor, or execute a particular function. The auxiliary processor may be implemented as being separate from, or a part of, the main processor.

In some examples, memory 115 may store various data used by at least one component (e.g., processor 110, etc.) of device 105. The various data may include, for example, software (e.g., a program, application) and input data or output data for a command related thereto. In some cases, memory 115 may include volatile memory (e.g., random-access memory (RAM) dynamic RAM (DRAM), static RAM (SRAM)) and/or non-volatile memory (e.g., NAND flash memory). In some cases, memory 115 and/or storage device 120 may include internal memory and/or external memory. One or more programs may be stored in the memory 115 as software, and may include, for example, an operating system (OS), middleware, and/or an application.

In some cases, timer 125 may be configured to time one or more operations, indicate or measure a time period, indicate a lapse of time, indicate an expiration, indicate a timeout, etc. In some cases, timer 125 may be configured to indicate a lapse of time, indicate an expiration, and/or indicate a timeout in relation to one or more components of device 105. For example, timer 125 may be configured to indicate a lapse of time and/or provide a clock cycle in relation to an operation of one or more components of device 105.

In some examples, PHY 130 may include an electronic circuit configured to implement physical layer functions of the open systems interconnection (OSI) model (e.g., in conjunction with a network interface controller of device 105). PHY 130 may connect a link layer device (e.g., medium access control (MAC) to a physical medium of device 105 (e.g., radio waves, electromagnetic radiation, radiofrequency (RF) energy).

In some examples, power supply 135 (e.g., a battery, a power adapter, power management module, etc.) may supply power to at least one component of device 105. In some examples, power supply 135 may include, for example, a cell (e.g., primary cell) that is not rechargeable, a cell (e.g., secondary cell) that is rechargeable, a fuel cell, etc.

A communication module of device 105 may support establishing a direct (e.g., wired) communication channel and/or a wireless communication channel between device 105 and at least one external electronic device and performing communication via the established communication channel. The communication module may include one or more communication processors that are operable independently from processor 110 and may support a direct (e.g., wired) communication and/or a wireless communication. The communication module may include a wireless communication module (e.g., a cellular communication module, a short-range wireless communication module, transmitter 145, receiver 150, antenna 160, etc.) or a wired communication module (e.g., a local area network (LAN) communication module, a power line communication (PLC) module, etc.). A corresponding one of these communication modules may communicate with the external electronic device via at least a first network (e.g., a short-range communication network, such as BLUETOOTH®, wireless-fidelity (Wi-Fi) direct, a standard of the Infrared Data Association (IrDA)) or a second network (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module may identify and/or may authenticate device 105 in a communication network using subscriber information (e.g., international mobile subscriber identity (IMSI)) stored in the subscriber identification module.

In some examples, antenna 160 (e.g., of transmitter 145 and/or receiver 150) may transmit a signal (e.g., RF energy) to and/or receive a signal from or one or more devices external to device 105. Antenna 160 may include one or more antennas. For example, antenna 160 may include at least one antenna appropriate for a communication scheme used in the communication network. A signal or power received by antenna 160 may be received by receiver 150 of device 105, and/or a signal or power transmitted by antenna 160 may be generated by transmitter 145.

Commands or data may be transmitted or received between device 105 and an external electronic device via a server coupled to at least one network. All or some of the operations executed at device 105 may be executed at one or more external electronic devices. For example, if device 105 performs a function or a service automatically, or in response to a request from a user or another device, device 105, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to device 105. The device 105 may provide the outcome, with or without further processing of the outcome, as at least part of a reply to the request. To that end, a cloud computing, distributed computing, or client-server computing technology may be used, for example.

In some examples, device 105 may be configured as a first access point communicating in conjunction with a second access point. In some cases, processor 110 may execute software (e.g., a program) to control at least one other component (e.g., a hardware, a software component, etc.) of device 105 coupled with processor 110. Processor 110 may perform various data processing or computations. For example, processor 110 may perform one or more operations for coordinated beamforming transmission between device 105 and an access point (e.g., another access point) in a wireless local area network.

In some examples, device 105 may be configured as a first access point communicating in conjunction with a second access point. In some cases, processor 110, in conjunction with transmitter 145, may transmit an invitation to a second access point, where the invitation is for a coordinated beamforming transmission that proposes a set of candidate stations associated with device 105 (the first access point). The invitation may include an overlapping basic service set channel state information status that identifies stations associated with the access point for which device 105 has valid channel state information. In some cases, processor 110, in conjunction with receiver 150, may receive a response that embeds an overlapping basic service set channel state information status identifying stations associated with device 105 (the first access point) for which the second access point has valid channel state information. In some cases, processor 110 may use the overlapping basic service set channel state information statuses carried in the invitation and the response to select stations for the coordinated beamforming transmission.

In some examples, device 105 may be configured as the second access point communicating in conjunction with the first access point. In some cases, processor 110, in conjunction with receiver 150, may receive the invitation from the first access point. Based on receiving the invitation, processor 110, in conjunction with transmitter 145, may transmit the response to the first access point. In some cases, processor 110 may use the overlapping basic service set channel state information statuses carried in the invitation and the response to select stations for the coordinated beamforming transmission.

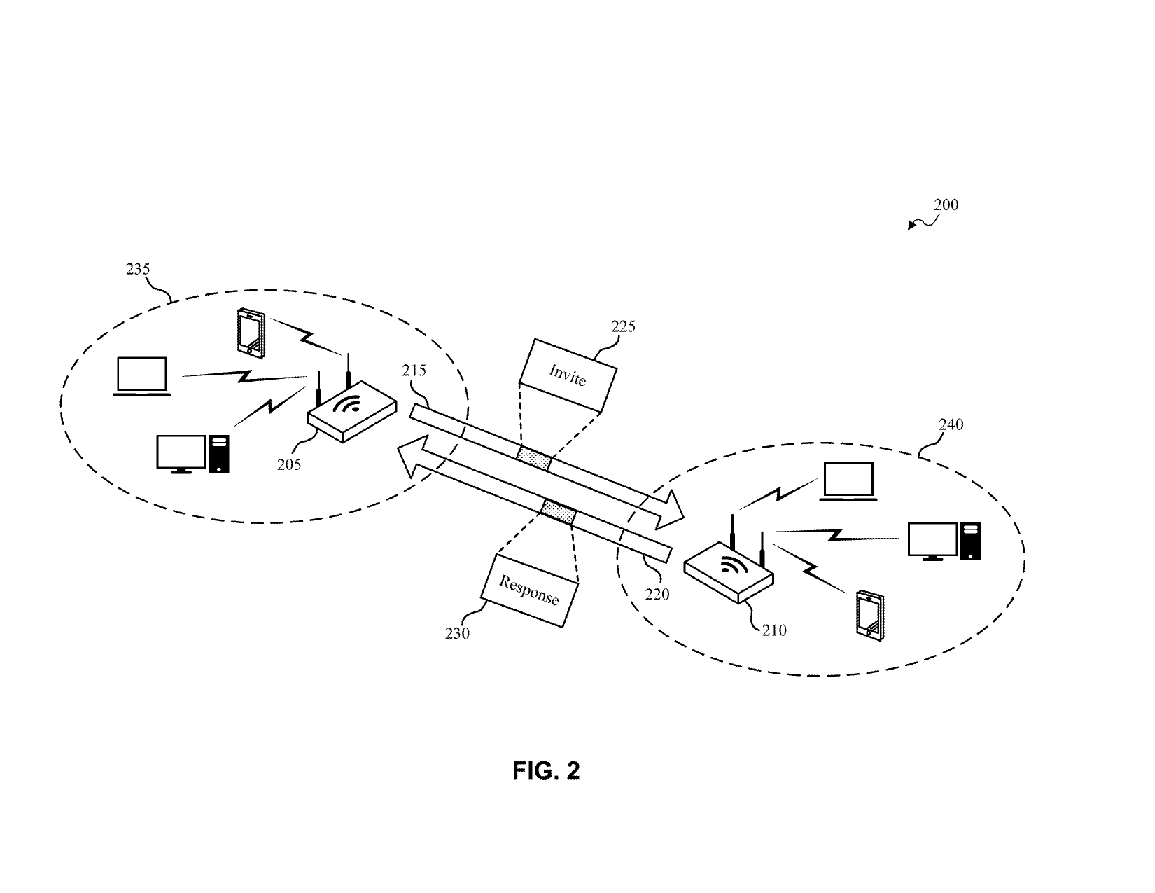

FIG. 2 illustrates an example of system 200, of a wireless communications network, that supports status exchange of overlapping basic service sets channel state information based on coordinated beamforming with example implementations described herein.

As illustrated, system 200 may include device 210 and device 205. In some cases, device 205 may be a first access point and device 210 may be a second access point. Device 210 or device 205 may be an example of device 105, as described above with reference to FIG. 1. System 200 may also include link 215 and link 220. Device 205 may use link 215 to convey control and/or data information to device 210. And device 210 may use link 220 to convey control and/or data information to device 205. In some cases, device 205 may be associated with a geographic coverage area 235 in which communications with one or more STAs (e.g., computing devices, laptops, desktops, mobile devices, etc.) is supported. In some cases, device 210 may be associated with a geographic coverage area 240 in which communications with one or more STAs (e.g., computing devices, laptops, desktops, mobile devices, etc.) is supported.

Device 210 may receive one or more transmissions from device 205. Similarly, device 205 may receive one or more transmissions from device 210. As shown, device 205 may generate invite 225 and transmit invite 225 to device 210. Device 205 may transmit invite 225 during a coordinated beamforming transmission stage. Invite 225 may include an invitation for a coordinated beamforming transmission that proposes a set of candidate stations associated with device 205. Invite 225 may include an overlapping basic service set channel state information status that identifies stations associated with device 210 for which device 205 has valid channel state information.

Device 210 may receive and process invite 225. Device 210 may generate response 230 based on receiving and processing invite 225. As shown, device 210 may transmit response 230 to device 205. Device 210 may transmit response 230 during the coordinated beamforming transmission stage. Response 230 may include a response that embeds an overlapping basic service set channel state information status. Response 230 may identify stations associated with device 205 for which device 210 has valid channel state information.

Device 205 and/or device 210 may use the overlapping basic service set channel state information statuses carried in invite 225 and response 230 to select stations for the coordinated beamforming transmission.

With coordinated beamforming (Co-BF), a first access point (e.g., device 205) and a second AP (e.g., device 210) may be configured with the overlapping basic service sets (OBSS) channel state information (CSI) of the interference links. The OBSS CSI status of the first AP may be unknown to the second AP without CSI status exchange. OBSS CSI status information exchange may be used relatively often for Co-BF transmission. Without OBSS CSI status information exchange, one of the APs may keep proposing unsuitable stations (STAs) to participate in Co-BF transmission. CSI status exchange with additional sequence(s) may not be favored due to increased complexity. The systems and methods described herein may include and/or may be based on a mechanism to exchange the OBSS CSI status between two APs using frames (e.g., Invite 225 and Response 230, or other 802.11 frames). In some cases, other 802.11 frames may be used instead of the invite frame (invite 225) and/or response frame (response 230). 802.11 frames that may be used in place of invite 225 and/or response 230 include a management frame, control frame, data frame, etc.

Accordingly, in a Co-BF transmission stage, DEVICE 205 and DEVICE 210 may exchange OBSS CSI status using existing Invite/Response frames (e.g., invite 225, response 230)., which allows for OBSS CSI status exchange in Co-BF transmission without new frame exchanges in either sounding or transmission stages.

In the invite frame (invite 225) , the sharing AP or coordinating AP (DEVICE 205) proposes its candidates from STAs associated with it (e.g., depicted STAs of DEVICE 205) based on its current knowledge of OBSS CSI status from the shared AP (DEVICE 210) and share the OBSS CSI status. In the response frame (response 230), the shared AP or coordinated AP (DEVICE 210) shares the OBSS CSI status and proposes candidates based the OBSS CSI status it just received from the sharing AP (DEVICE 205). The OBSS CSI status exchange helps not only in the current Co-BF transmission, but a subsequent Co-BF transmission. The format of CSI status can be a list of OBSS STAs of which an AP has CSI knowledge. The list could be signaled in any suitable format. In some cases, the configuration also allow for having a limit on the maximum number of STAS (associated with the partner AP) in the OBSS CSI status information.

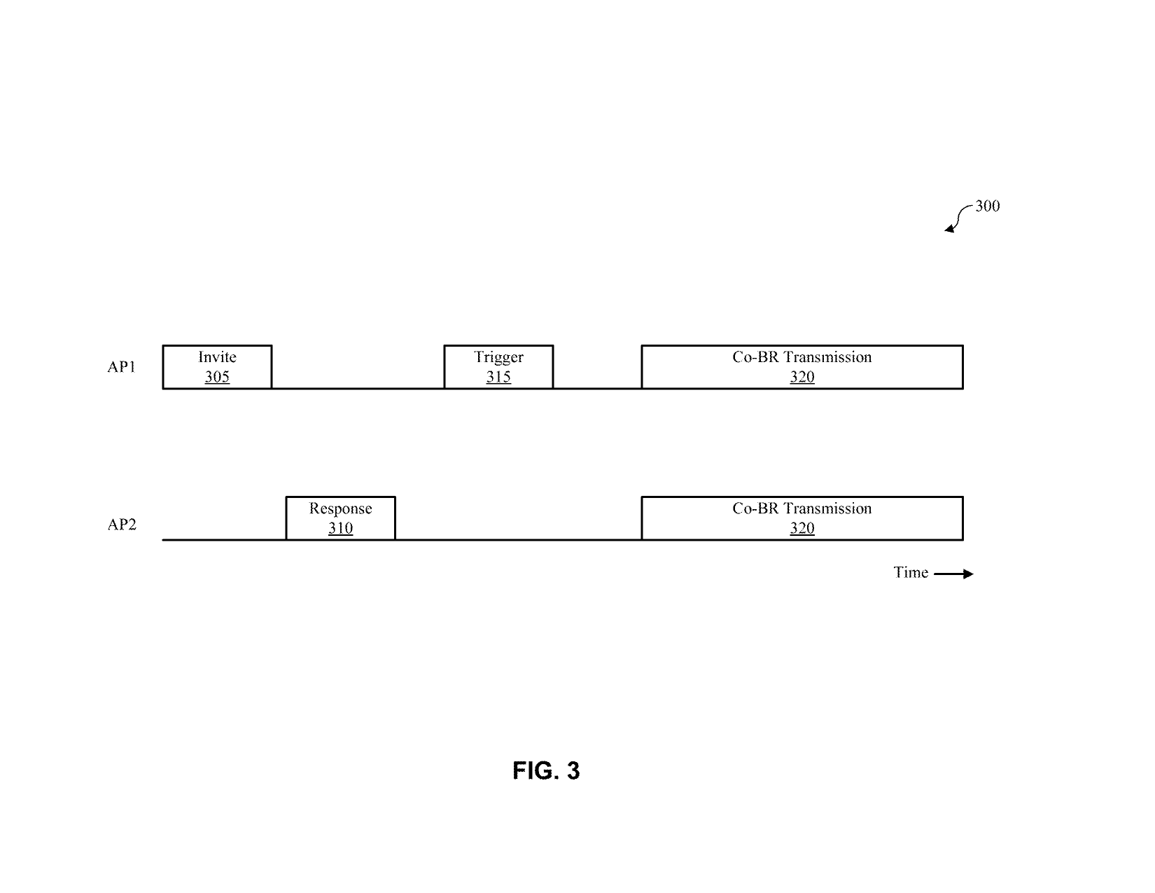

FIG. 3 illustrates an example timeline 300 in accordance with one or more implementations as described herein. In some configurations, one or more aspects of timeline 300 may be implemented by or in conjunction with device 105, one or more components of device 105, system 200, or any combination thereof.

Timeline 300 depicts a Co-BF transmission sequence. AP1 refers to the sharing AP (e.g. coordinating AP, DEVICE 205) and AP2 refers to the shared AP (e.g., coordinated AP, DEVICE 210). Timeline 300 includes a timeline of AP1 in relation to a timeline of AP2, where the timeline of AP1 overlaps the timeline of AP2. Time runs from the left to the right. At the start of the AP1 timeline is an Invite frame (invite 305) that AP1 sends to AP2. Invite 305 may be an example of invite 225. The AP2 timeline is empty for the portion of the AP2 timeline that corresponds to the span of the Invite frame on the AP1 timeline.

On the AP2 timeline, after the end of the Invite frame on the AP1 timeline, there is a Response frame from AP2 (response 310). The AP1 timeline is empty for the portion of the AP1 timeline that corresponds to the span of the Response frame on the AP2 timeline. On the AP1 timeline, after the end of the Response frame on the AP2 timeline, there is a Trigger frame from AP1 (trigger 315). The AP2 timeline is empty for the portion of the AP2 timeline that corresponds to the span of the Trigger frame on the AP1 timeline. On the AP1 timeline and the AP2 timeline, there is the Co-BF transmission (e.g., Co-BF transmission 320). The Co-BF Transmission on the AP1 timeline overlaps with the Co-BF Transmission on the AP2 timeline.

The trigger frame may be a control frame transmitted by the coordinating AP (AP1) to finalize and initiate the Co-BF transmission. The trigger frame may convey a final set of selected STAs and transmission parameters for the upcoming Co-BF transmission (e.g., STA identifiers, spatial stream assignments, resource allocations, modulation and coding, timing, etc.), reflecting any adjustments informed by the OBSS CSI status exchanged in the Invite/Response. The trigger frame may provide the timing/synchronization cue that precedes and initiates the concurrent downlink transmissions by AP1 and AP2. If AP2 provides updated OBSS CSI status in the Response, AP1 can re-propose or refine the candidate STA set in the trigger frame before the coordinated transmission proceeds.

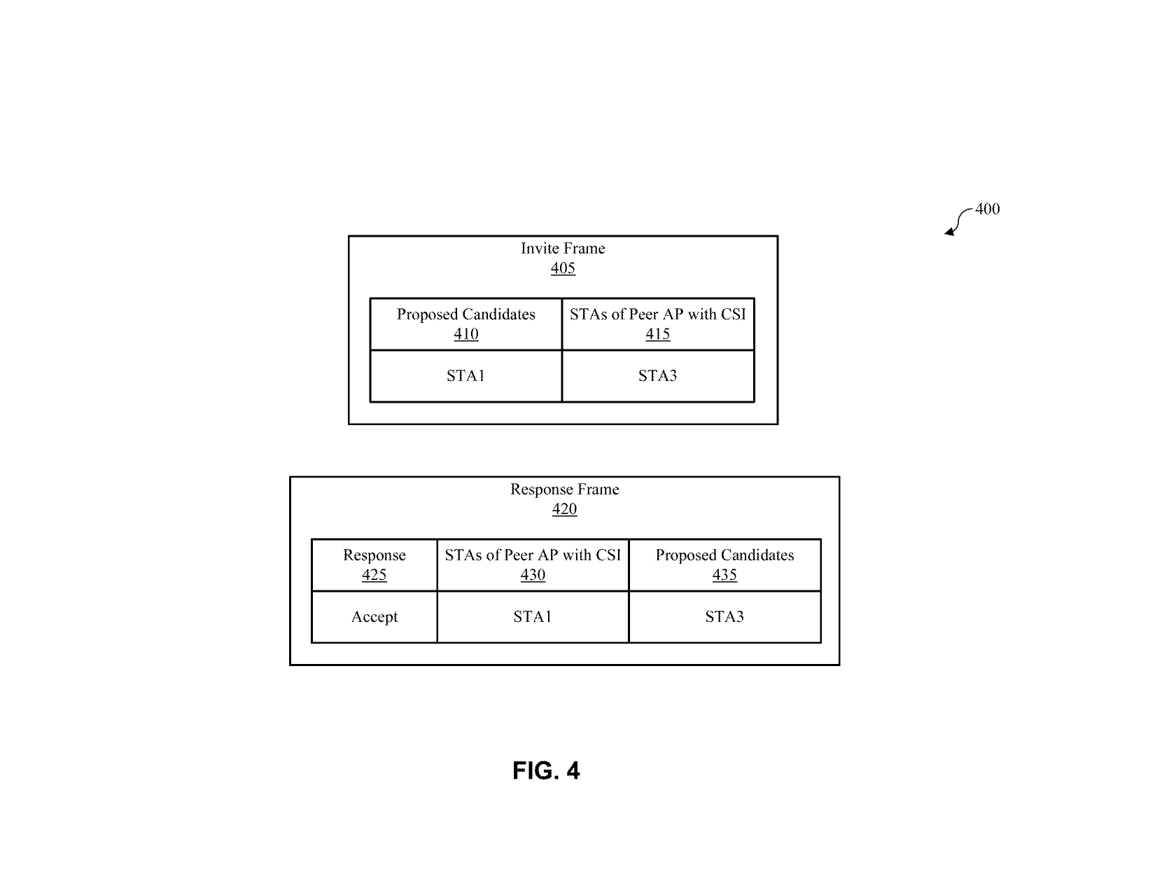

FIG. 4 illustrates an example transmission sequence 400 in accordance with one or more implementations as described herein. In some configurations, one or more aspects of transmission sequence 400 may be implemented by or in conjunction with device 105, one or more components of device 105, system 200, or any combination thereof.

In the illustrated example, transmission sequence 400 includes invite frame 405 and response frame 420. Invite frame 405 and response frame 420 each include one or more fields. The depicted fields of invite frame 405 include proposed candidates 410 and STAs of peer AP with CSI 415. The depicted fields of response frame 420 include response 425, STAs of peer AP with CSI 430, and proposed candidates 435.

In invite frame 405, the sharing AP or coordinating AP (e.g., AP1, DEVICE 205) may include a list of candidate STAs for Co-BF transmission that are associated with the sharing AP, and/or include a list of STAs that are associated with the shared AP and that have updated OBSS CSI at the sharing AP.

After receiving invite frame 405, in the Response frame, the shared AP or coordinated AP (e.g., AP2, DEVICE 210) may include a list of STAs that are associated with the sharing AP and that have updated OBSS CSI at the shared AP.

When the shared AP accepts the invite, the shared AP may propose a list of candidate STAs associated with the shared AP from the list of available OBSS CSI STAs provided by the sharing AP. After the invite/response frame exchanges, both APs have the complete OBSS CSI status (e.g., regardless whether the shared AP rejects or accepts the invite).

In the depicted example, the sharing AP (AP1) has STA1 and STA2 associated with it. The shared AP (AP2) has STA3 and STA4 associated with it. AP1 has OBSS CSI of 3; OBSS CSI of STA4 is not received. AP2 has OBSS CSI of 1; OBSS CSI of STA2 is not received.

Based on the depicted example, the sharing AP may propose a candidate STA via proposed candidates 410 of invite frame 405 (e.g., proposes STA1). Also, the sharing AP may share that it holds valid OBSS CSI for one of the partner AP’s STAs (e.g., but not for another). As shown, the sharing AP may indicate STA3 in STAs of peer AP with CSI 415.

The shared AP may indicate Accept or Reject in response 425. In the illustrated example, the shared AP may verify it has CSI for the proposed candidate and accept, while proposing a candidate from its side that the sharing AP’s status indicates is supported. As shown, the shared AP indicates Accept in response 425. Also, the shared AP indicates STA1 in STAs of peer AP with CSI 430, and indicates STA3 in proposed candidates 435.

By embedding OBSS CSI status in existing Invite and Response frames and performing the exchange during Co-BF transmission setup, the disclosed techniques eliminate additional sequences and overhead, reduce complexity, and improve reliability. Continuous status refresh mitigates the impact of CSI expiration and eviction, avoids repeated proposals of unsuitable candidates, and increases the success rate of Co-BF transmissions, thereby improving throughput, latency, and overall system performance in 802.11bn.

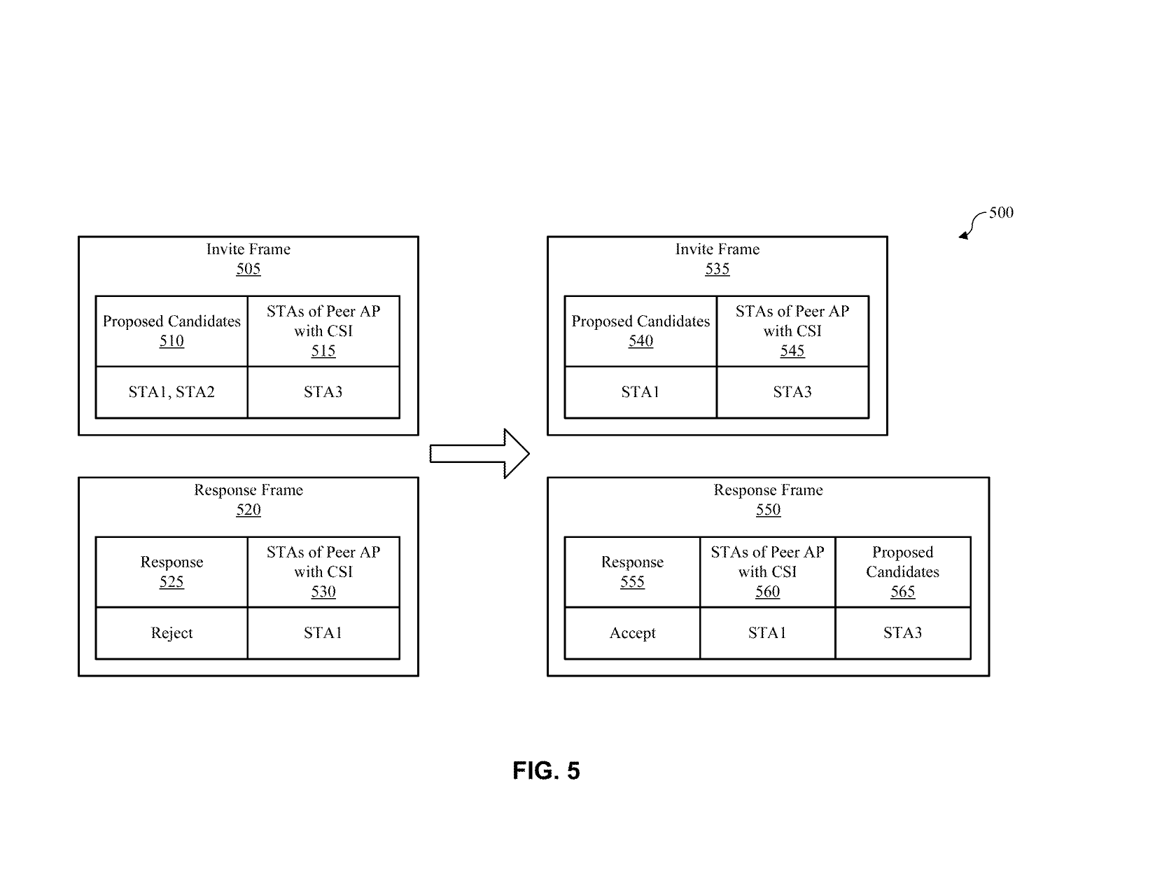

FIG. 5 illustrates an example transmission sequence 500 in accordance with one or more implementations as described herein. In some configurations, one or more aspects of transmission sequence 500 may be implemented by or in conjunction with device 105, one or more components of device 105, system 200, or any combination thereof.

In the illustrated example, transmission sequence 500 includes invite frame 505, response frame 520, invite frame 535, and response frame 550. Invite frame 505 and response frame 520 may be part of a first invite/response frame transmission sequence. Invite frame 535 and response frame 550 may be part of a second invite/response frame transmission sequence (e.g., retry) based on the first sequence.

In the depicted example, the sharing AP (AP1) has STA1 and STA2 associated with it. The shared AP (AP2) has STA3 and STA4 associated with it. AP1 has OBSS CSI of 3; OBSS CSI of 4 is not received. AP2 has OBSS CSI of 1; OBSS CSI of 2 is not received.

In invite frame 505, the sharing AP proposes candidates. As shown, invite frame 505 includes the following fields: proposed candidates 510 (proposes STA1, STA2) and STAs of peer AP with CSI 515 (STA3).

In the depicted example, the shared AP lacks OBSS CSI for one candidate and rejects the invite. Response frame 520 includes the following fields: response 525 (reject) and STAs of peer AP with CSI 515 (STA1). Nevertheless, the shared AP’s response frame conveys its current OBSS CSI status so that the sharing AP can propose suitable candidates in the next attempt. The exchange ensures both parties converge on compatible STA selections and reduces failed negotiations arising from stale or incomplete CSI knowledge.

In transmission sequence 500, even though AP2 rejects the invitation in the first Co-BF transmission because AP1 proposed unsuitable candidate STA2, for which AP2 has no OBSS CSI, the CSI status exchange is still completed between the APs. Therefore, in the next Co-BF transmission, AP1 can use the information from response to exclude STA2 from its candidate list.

As shown, invite frame 535 includes the following fields: proposed candidates 540 (proposes STA1; STA2 not proposed) and STAs of peer AP with CSI 545 (STA3). Response frame 550 includes the following fields: response 555 (accept), STAs of peer AP with CSI 560 (STA1), and proposed candidates 565 (STA3).

In the first invite/response exchange, AP2 may not reject the invitation in some cases. For example, AP2 may accept the invitation (e.g., response 525 indicates “accept”) and provide the CSI status. AP1 may then re-propose the suitable candidates in the trigger frame based on the CSI status from AP2.

To simplify signaling, the CSI status size may be limited. For example, the number of STAs for which an AP has OBSS CSI may be limited to some fixed number (e.g., any number between 1 and 10, such as 3). The signaling of the CSI status may be any format suitable.

In some examples, the sharing AP may include a field in the Invite frame that lists the association identifiers (AIDs) of the non-AP STAs of the other BSS that have OBSS CSI available at the sharing AP. In the Response frame, the shared AP may include a field that lists the AIDs of the non-AP STAs of the other BSS that have OBSS CSI available at the shared AP.

By embedding OBSS CSI status in existing Invite and Response frames and performing the exchange during every Co-BF transmission setup, the invention eliminates additional sequences and overhead, reduces complexity, and improves reliability. Continuous status refresh mitigates the impact of CSI expiration and eviction, avoids repeated proposals of unsuitable candidates, and increases the success rate of Co-BF transmissions, thereby improving throughput, latency, and overall system performance in 802.11bn.

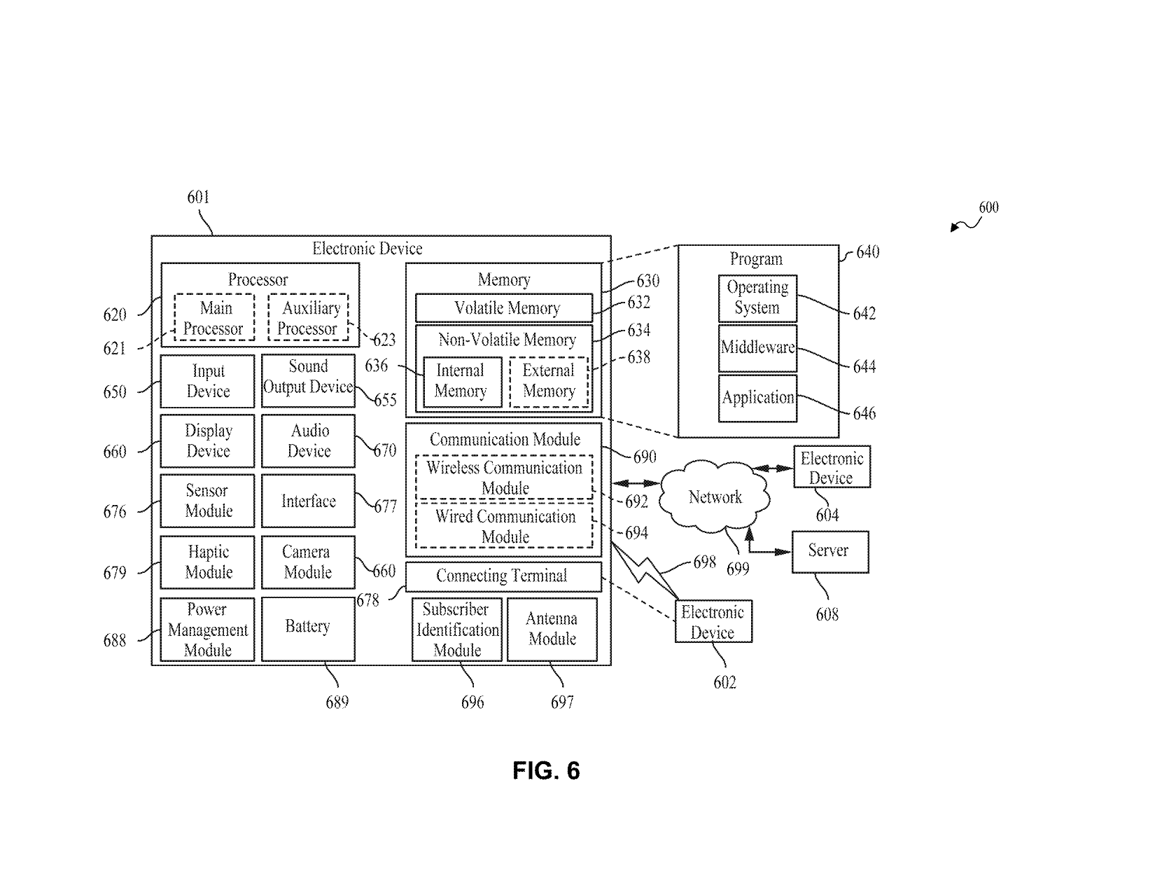

FIG. 6 is a block diagram of an electronic device in a network environment 600, according to an embodiment. In some cases, one or more components of network environment 600 (e.g., processor 620, memory 630, communication module 690, etc.) may support status exchange of overlapping basic service sets channel state information based on coordinated beamforming with example implementations described herein.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high- definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH^{TM}, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the SIM card 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of the operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

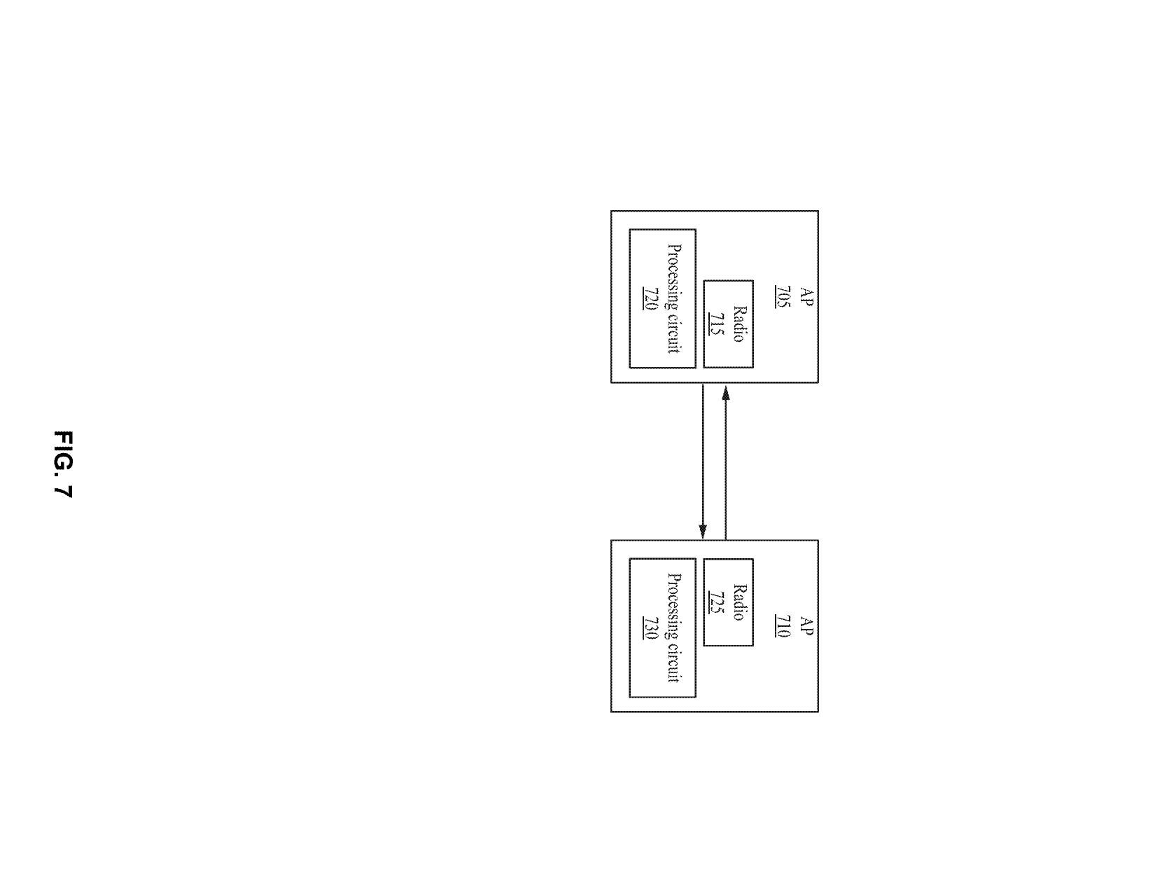

FIG. 7 depicts a system including AP 705 and AP 710, in communication with each other. AP 705 and AP 710 may support status exchange of overlapping basic service sets channel state information based on coordinated beamforming with example implementations described herein (e.g., in conjunction with one or more STAs).

As shown, AP 705 may include a radio 715 and a processing circuit (or a means for processing) 720, which may perform various methods disclosed herein. For example, the processing circuit 720 may receive, via the radio 715, transmissions from AP 710, and the processing circuit 720 may transmit, via the radio 715, signals to AP 710.

As shown, AP 710 may include a radio 725 and a processing circuit (or a means for processing) 730, which may perform various methods disclosed herein. For example, the processing circuit 730 may receive, via the radio 725, transmissions from AP 705, and the processing circuit 730 may transmit, via the radio 725, signals to AP 705.

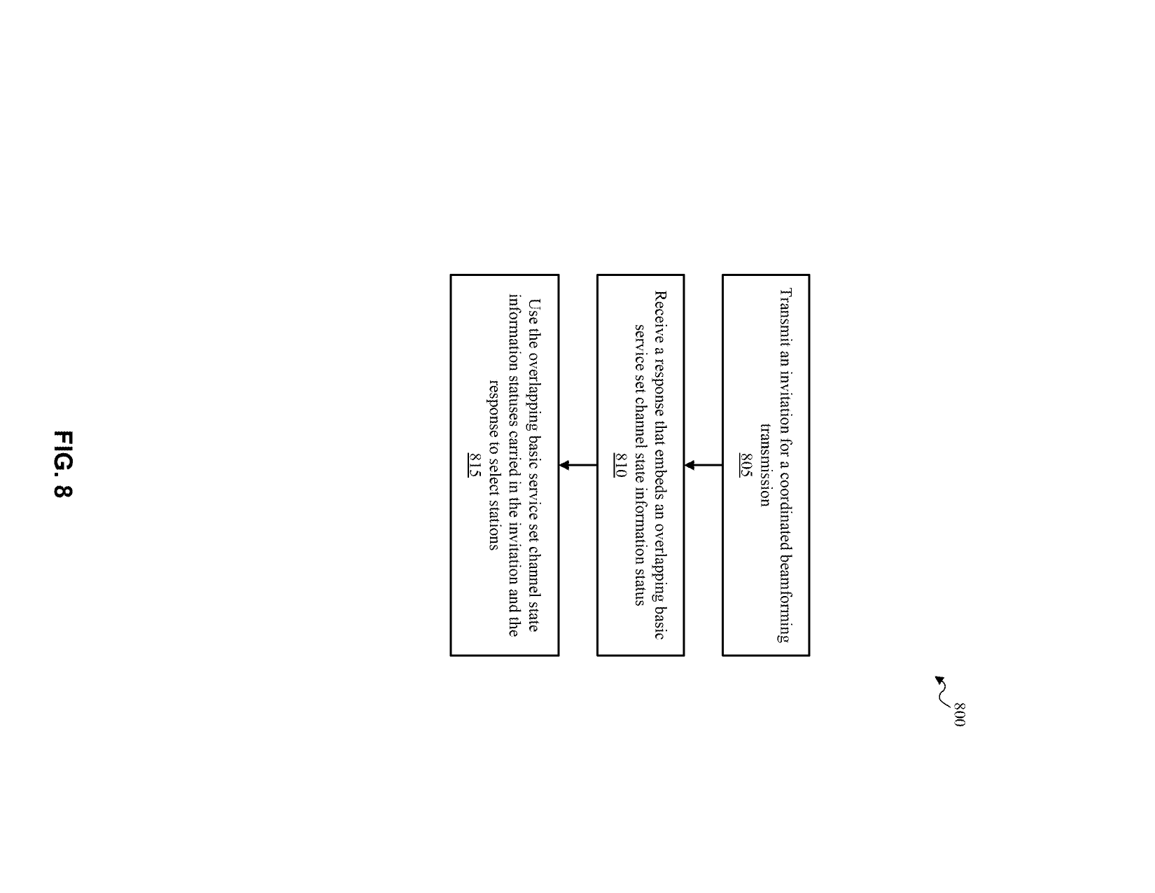

FIG. 8 depicts a flow diagram illustrating an example method 800 associated with the disclosed systems, in accordance with example implementations described herein. Method 800 may depict a method for coordinated beamforming transmission between a first access point and a second access point in a wireless local area network.

In some configurations, one or more aspects of method 800 may be implemented by or in conjunction with device 105, one or more components of device 105, system 200, one or more components of system 200, network environment 600, one or more components of network environment 600, or any combination thereof. The depicted method 800 is just one implementation and one or more operations of method 800 may be rearranged, reordered, omitted, and/or otherwise modified such that other implementations are possible and contemplated.

At 805, method 800 may include transmitting an invitation for a coordinated beamforming transmission. For example, a first access point may transmit, to a second access point and during a coordinated beamforming transmission stage, an invitation for a coordinated beamforming transmission that proposes a set of candidate stations associated with the first access point, the invitation including an overlapping basic service set channel state information status that identifies stations associated with the second access point for which the first access point has valid channel state information.

At 810, method 800 may include receiving a response that embeds an overlapping basic service set channel state information status. For example, the first access point may receive, at the first access point during the coordinated beamforming transmission stage, a response that embeds an overlapping basic service set channel state information status identifying stations associated with the first access point for which the second access point has valid channel state information.

At 815, method 800 may include using the overlapping basic service set channel state information statuses carried in the invitation and the response to select stations. For example, the first access point may use the overlapping basic service set channel state information statuses carried in the invitation and the response to select stations for the coordinated beamforming transmission.

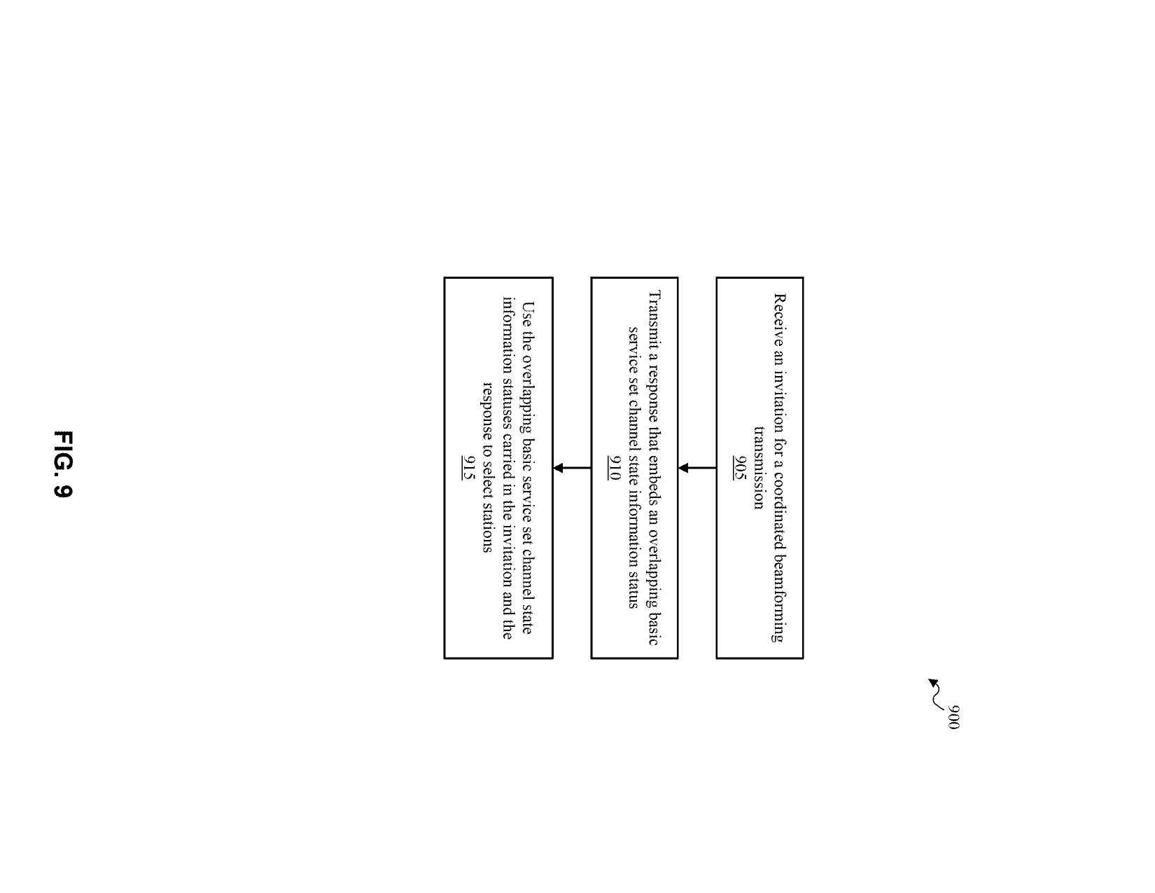

FIG. 9 depicts a flow diagram illustrating an example method 900 associated with the disclosed systems, in accordance with example implementations described herein. Method 900 may depict a method for coordinated beamforming transmission between a first access point and a second access point in a wireless local area network.

In some configurations, one or more aspects of method 900 may be implemented by or in conjunction with device 105, one or more components of device 105, system 200, one or more components of system 200, network environment 600, one or more components of network environment 600, or any combination thereof. The depicted method 900 is just one implementation and one or more operations of method 900 may be rearranged, reordered, omitted, and/or otherwise modified such that other implementations are possible and contemplated.

At 905, method 900 may include receiving an invitation for a coordinated beamforming transmission (e.g., in conjunction with a first access point and a second access point). For example, the second access point may receive, from the first access point and during a coordinated beamforming transmission stage, an invitation for a coordinated beamforming transmission that proposes a set of candidate stations associated with the first access point, the invitation including an overlapping basic service set channel state information status that identifies stations associated with the second access point for which the first access point has valid channel state information.

At 910, method 900 may include transmitting a response that embeds an overlapping basic service set channel state information status. For example, the second access point may transmit, to the first access point during the coordinated beamforming transmission stage, a response that embeds an overlapping basic service set channel state information status identifying stations associated with the first access point for which the second access point has valid channel state information.

At 915, method 900 may include using the overlapping basic service set channel state information statuses carried in the invitation and the response to select stations. For example, the second access point may use the overlapping basic service set channel state information statuses carried in the invitation and the response to select stations for the coordinated beamforming transmission.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

A number of example implementations have been described. Nevertheless, it will be understood that various modifications may be made without departing from the spirit and scope of the disclosure. Accordingly, additional implementations are within the scope of the following claims. As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for coordinated beamforming transmission between a first access point and a second access point in a wireless local area network, the method comprising:
transmitting, at the first access point to the second access point and during a coordinated beamforming transmission stage, an invitation for a coordinated beamforming transmission that proposes a set of candidate stations associated with the first access point, the invitation including a first overlapping basic service set channel state information status that identifies stations associated with the second access point for which the first access point has valid channel state information;
receiving, at the first access point during the coordinated beamforming transmission stage, a response that embeds a second overlapping basic service set channel state information status identifying stations associated with the first access point for which the second access point has valid channel state information; and
using the first and second overlapping basic service set channel state information statuses carried in the invitation and the response to select stations for the coordinated beamforming transmission.

2. The method of claim 1, wherein the response further includes a set of candidate stations associated with the second access point, the set selected from stations indicated in the invitation as having valid overlapping basic service set channel state information at the first access point.

3. The method of claim 1, wherein:
the response indicates acceptance or rejection of the invitation based on whether the second access point has valid overlapping basic service set channel state information for each proposed candidate station associated with the first access point, and
the response embeds the second overlapping basic service set channel state information status whether the invitation is accepted or rejected.

4. The method of claim 3, wherein the first access point, upon receiving a rejection that embeds the second overlapping basic service set channel state information status, generates a revised set of candidate stations for a subsequent coordinated beamforming transmission attempt based on the embedded status and initiates a new invitation without performing a separate channel state information status exchange sequence.

5. The method of claim 1, wherein overlapping basic service set channel state information status of the invitation or response is encoded as a list of association identifiers of stations, each association identifier represented by an 11-bit or 12-bit field.

6. The method of claim 1, wherein overlapping basic service set channel state information status of the invitation or response is encoded as a multi-bit bitmap in which each bit position maps to a station according to a predetermined ordering rule that is based on respective station association identifiers.

7. The method of claim 1, wherein an overlapping basic service set channel state information status field includes a limit on a number of stations reported, the limit corresponding to a maximum number of stations supported in coordinated beamforming transmission or a memory capacity constraint of the first access point.

8. The method of claim 1, further comprising:
updating a local cache of overlapping basic service set channel state information status based on the statuses carried in the invitation and the response, and
evicting cached overlapping basic service set channel state information according to priority or memory size constraints, the updated cache being used for a subsequent coordinated beamforming negotiation.

9. The method of claim 1, further comprising embedding, in lieu of or in addition to the invitation, the first overlapping basic service set channel state information status in at least one of a management frame, a control frame, or a data frame associated with the coordinated beamforming transmission.

10. A method for coordinated beamforming transmission between a first access point and a second access point in a wireless local area network, the method comprising:
receiving, from the first access point and during a coordinated beamforming transmission stage, an invitation for a coordinated beamforming transmission that proposes a set of candidate stations associated with the first access point, the invitation comprising a first overlapping basic service set channel state information status that identifies stations associated with the second access point for which the first access point has valid channel state information;
transmitting, at the second access point during the coordinated beamforming transmission stage and based on the invitation, a response generated by the second access point and that embeds a second overlapping basic service set channel state information status identifying stations associated with the first access point for which the second access point has valid channel state information; and
using the first and second overlapping basic service set channel state information statuses carried in the invitation and the response to select stations for the coordinated beamforming transmission.

11. The method of claim 10, wherein the response further includes a set of candidate stations associated with the second access point, the set selected from stations indicated in the invitation as having valid overlapping basic service set channel state information at the first access point.

12. The method of claim 10, wherein:
the response indicates acceptance or rejection of the invitation based on whether the second access point has valid overlapping basic service set channel state information for each proposed candidate station associated with the first access point, and
the response embeds the second overlapping basic service set channel state information status, whether the invitation is accepted or rejected.

13. The method of claim 10, wherein overlapping basic service set channel state information status of the invitation or response is encoded as a list of association identifiers of stations, each association identifier represented by an 11-bit or 12-bit field.

14. The method of claim 10, wherein overlapping basic service set channel state information status of the invitation or response is encoded as a multi-bit bitmap in which each bit position maps to a station according to a predetermined ordering rule that is based on respective station association identifiers.

15. The method of claim 10, wherein an overlapping basic service set channel state information status field includes a limit on a number of stations reported, the limit corresponding to a maximum number of stations supported in coordinated beamforming transmission or a memory capacity constraint of the second access point.

16. The method of claim 10, further comprising:
updating a local cache of overlapping basic service set channel state information status based on the statuses carried in the invitation and the response, and
evicting cached overlapping basic service set channel state information according to priority or memory size constraints, the updated cache being used for a subsequent coordinated beamforming negotiation.

17. The method of claim 10, further comprising:
the second access point determining whether to accept the invitation based on verifying a validity of overlapping basic service set channel state information for each proposed candidate station of the first access point.

18. The method of claim 10, further comprising:
the second access point determining whether to accept the invitation based on applying scheduling criteria including at least one of station buffer status, station data priority, or station availability.

19. The method of claim 10, further comprising embedding, in lieu of or in addition to the response, the second overlapping basic service set channel state information status in at least one of a management frame, a control frame, or a data frame associated with the coordinated beamforming transmission.

20. A first access point comprising one or more processors and memory storing instructions that, when executed by the one or more processors, cause the first access point to:
transmit, at the first access point to a second access point and during a coordinated beamforming transmission stage, an invitation for a coordinated beamforming transmission that proposes a set of candidate stations associated with the first access point, the invitation including a first overlapping basic service set channel state information status that identifies stations associated with the second access point for which the first access point has valid channel state information;
receive, at the first access point during the coordinated beamforming transmission stage, a response that embeds a second overlapping basic service set channel state information status identifying stations associated with the first access point for which the second access point has valid channel state information; and
use the first and the second overlapping basic service set channel state information statuses carried in the invitation and the response to select stations for the coordinated beamforming transmission.
